(19) United States
(12) Patent Application Publication
(10) Pub. No.: US 2024/0176752 A1
(43) Pub. Date: May 30, 2024

(54) SIGNAL PROCESSOR AND SIGNAL PROCESSING SYSTEM

(71) Applicant: ROHM CO., LTD., Kyoto-shi (JP)

(72) Inventors: Naoki TADA, Kyoto-shi (JP); Masanori ONODERA, Kyoto-shi (JP)

(21) Appl. No.: 18/510,919

(22) Filed: Nov. 16, 2023

(30) Foreign Application Priority Data
Nov. 28, 2022 (JP) 2022-189505

(51) Int. Cl. G06F 13/16; G06F 12/06

(52) U.S. Cl. CPC G06F 13/1689; G06F 12/0653; G06F 13/1631

(57) ABSTRACT

The present disclosure provides a signal processor (signal processing device). The signal processor includes: a first terminal, into which one of a clock signal and a data signal is input; a second terminal, into which another one of the clock signal and the data signal is input; a storage unit, in which an address map is set to define an address permitting data writing and an address prohibiting data writing; a designation unit, configured to designate the address map set in the storage unit; and a processing unit, configured to write a data based on the data signal to the storage unit according to the address map designated by the designation unit. The designation unit may designate a first address map and a second address map different from the first address map.

### CROSS REFERENCES TO RELATED APPLICATIONS

The present invention claims priority under 35 U.S.C. § 119 to Japanese Application, 2022-189505, filed on Nov. 28, 2022, the entire contents of which being incorporated herein by reference.

### TECHNICAL FIELD

The present disclosure relates to a signal processor and a signal processing system.

### BACKGROUND

A communication bus that uses a clock line and a data line to transmit/receive data is available in the prior art. Such communication bus is, for example, an Inter-Integrated Circuit (I2C) bus.

### PRIOR ART DOCUMENT

### Patent Publication

[Patent document 1]: Japan Patent Publication No. 2014-153822

### BRIEF DESCRIPTION OF THE DRAWINGS

FIG. 1 is a diagram of a signal processing system of a reference example.

FIG. 2 is a diagram of a signal transmission/reception process in the signal processing system of the reference example.

FIG. 3 is a diagram of a configuration of a signal processing system according to an embodiment of the present disclosure.

FIG. 4 is a function block diagram of a signal processing device according to the embodiment of the present disclosure.

FIG. 5A is a diagram of a first address map according to the embodiment; FIG. 5B is a diagram of a second address map according to the embodiment.

FIG. 6 is an operation example of a signal processing system according to the embodiment.

FIG. 7 is a diagram of two signal processing devices observed from a master device of the embodiment.

FIG. 8A is a diagram of a first address map of a variation example. FIG. 8B is a diagram of a second address map of a variation example.

FIG. 9 is a diagram of address maps set by a first signal processing device and a second signal processing device of an application example.

FIG. 10A is a diagram of a communication process of writing data to a storage unit of a signal processing device. FIG. 10B is a diagram of a communication process of reading data from a storage unit of a signal processing device.

### DETAILED DESCRIPTION OF THE EMBODIMENTS

### Summary

A summary of several exemplary embodiments of the disclosure is given below. The summary serves as the introduction of the detailed description to be given shortly and aims at providing fundamental understanding of the embodiments by describing several concepts of one or more embodiments in brief. It should be noted that the summary is not to be construed as limitations to the scope of the application or disclosure. The summary is not an all-inclusive summary of all conceivable embodiments, nor does it intend to specify important elements of all embodiments or to define the scope of a part of or all aspects. For the sake of better description, “one embodiment” sometimes refers to one embodiment (an implementation example or a variation example) or multiple embodiments (implementation examples or variation examples) described in the disclosure.

In one embodiment, a signal processor (signal processing device) includes: a first terminal, into which one of a clock signal and a data signal is input; a second terminal, into which another one of the clock signal and the data signal is input; a storage unit, in which an address map is set to define an address permitting data writing and an address prohibiting data writing; a designation unit, configured to designate the address map set in the storage unit; and a processing unit, configured to write a data based on the data signal to the storage unit according to the address map designated by the designation unit. The designation unit designates a first address map when the clock signal is input into the first terminal and the data signal is input into the second terminal and designates a second address map different from the first address map when the data signal is input into the first terminal and the clock signal is input into the second terminal.

According to the configuration above, the signal processor writes data according to one of the two designated address maps. By using two of such signal processor, data corresponding to each address map can be written, and so the two signal processors can easily perform communications.

Further, in one embodiment, the signal processor can further include: a first detection unit, configured to detect a start of communication based on the clock signal and the data signal when the clock signal is input into the first terminal and the data signal is input into the second terminal; and a second detection unit, configured to detect a start of communication based on the clock signal and the data signal when the data signal is input into the first terminal and the clock signal is input into the second terminal. Further, the designation unit designates the first address map when the first detection unit detects a start and designates the second address map when the second detection unit detects a start. Accordingly, an address map can be more appropriately designated.

Further, in one embodiment, each of the first address map and the second address map includes a first address and a second address. Further, the first address, in the first address map, permits data writing and reading that data writing and reading are performed, and in the second address map, prohibits data writing and reading that data writing and reading are not performed. Further, the second address, in the first address map, prohibits data writing and reading that data writing and reading are not performed, in the second address map, permits data writing and reading that data writing and reading are performed. Accordingly, signal transmission/reception can be appropriately performed with two signal processors.

Further, in one embodiment, each of the first address map and the second address map includes a first address, a second address and a write address to which data is writable. Further, the first address, in the first address map, permits data to be written to the write address, and in the second address map, prohibits data to be written to the write address. Further, the second address, in the first address map, prohibits data to be written to the write address, and in the second address map, permits data to be written to the write address.

Further, in one embodiment, the signal processor further includes an output control unit configured to output a data written in the storage unit from the first terminal or the second terminal according to the address map designated by the designation unit. Accordingly, data can be readily and easily transmitted/received by two signal processors.

In another embodiment, a signal processing system includes a first signal processing device and a second signal processing device respectively configured by the signal processor. The first signal processing device is configured that the data signal is input into a first terminal of the first signal processing device, and the clock signal is input into a second terminal of the first signal processing device. The second signal processing device is configured that the clock signal is input into a first terminal of the second signal processing device, and the data signal is input into a second terminal of the second signal processing device. According to the configuration above, data can be readily and easily transmitted/received with the two signal processing devices.

In one embodiment, the data signal is configured that data is written to the storage unit of the first signal processing device according to the first address map, and data is written to the storage unit of the second signal processing device according to the second address map. Accordingly, data can be written to the two signal processors in one instance of communication.

### Reference Example

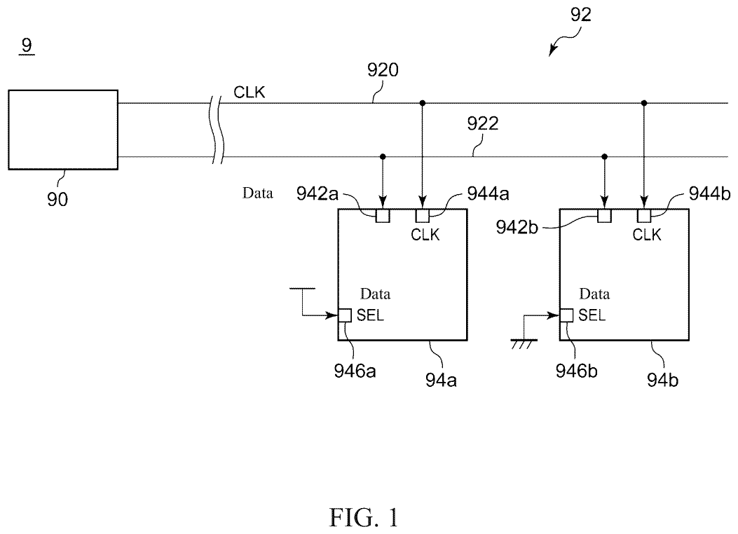

FIG. 1 shows a diagram of a signal processing system 9 of a reference example. As shown in FIG. 1, the signal processing system 9 of the reference example includes a master device 90, a communication bus 92, a first slave device 94a and a second slave device 94b. The master device 90 communicates with the first slave device 94a and the second slave device 94b via the communication bus 92.

The first slave device 94a and the second slave device 94b respectively perform various types of signal processing according to input signals. The first slave device 94a includes a data terminal 942a, a clock terminal 944a and an identification terminal 946a. Moreover, the second slave device 94b includes a data terminal 942b, a clock terminal 944b and an identification terminal 946b. The first slave device 94a and the second slave device 94b are provided with identification codes by using external terminals. More specifically, the first slave device 94a is provided with an identification code from an external terminal via the identification terminal 946a, and the second slave device 94b is provided with an identification code from an external terminal via the identification terminal 946b.

The communication bus 92 is connected to the master device 90, the first slave device 94a and the second slave device 94b and is used as a signal transmission path among the master device 90, the first slave device 94a and the second slave device 94b. The communication bus 92 has a clock line 920 and a data line 922.

The clock line 920 is connected to the master device 90, the clock terminal 944a of the first slave device 94a and the clock terminal 944b of the second slave device 94b. A clock signal from the master device 90 is transmitted to the first slave device 94a and the second slave device 94b via the clock line 920.

The data line 922 is connected to the master device 90, the data terminal 942a of the first slave device 94a and the data terminal 942b of the second slave device 94b. A data signal from the master device 90 is transmitted to the first slave device 94a and the second slave device 94b via the data line 922. Moreover, data from the first slave device 94a or the second slave device 94b is transmitted to the master device 90 via the data line 922.

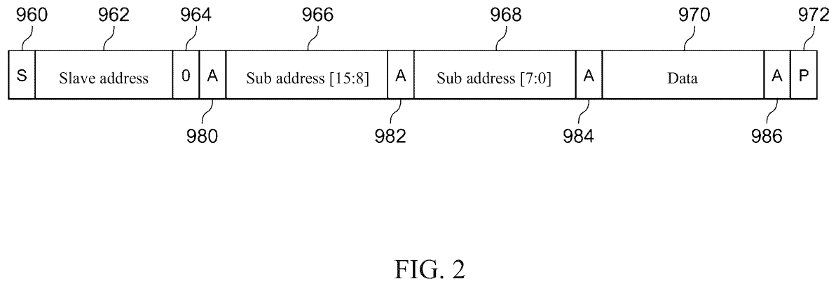

Referring to FIG. 2, a transmission/reception process of signals in the signal processing system 9 of the reference example is described below. The master device 90 sends start information 960 indicating a start of communication, and then sends slave address information 962 of a slave device to be identified as a communication target. The slave device (the first slave device 94a or the second slave device 94b) corresponding to the slave address information 962 can communicate with the master device 90.

Subsequent to the slave address information 962, the master device 90 sends instruction information 964 instructing to write data. Then, the master device 90 sends sub address information 966 and 968 for writing data, further sends a data 970 representing written data, and lastly sends stop information 972 indicating a stop of the communication. The slave device communicating with the master device 90 sends acknowledge information 980, 982, 984 and 986 to the master device 90 depending on requirements. Then, the slave device which is the communication target performs signal processing based on the information (the sub address information 966 and 968 and the data 970) sent from the master device 90 and writes data to an internal memory.

In general, when there are multiple devices connected to a communication bus, in order to communicate with any of these devices, it is necessary for the device to identify the device selected by a communication target. In the signal processing system 9 of the reference example, by identifying the identification codes (slave addresses) of the first slave device 94a and the second slave device 94b, the slave device is identified as the communication target. In the reference example, an external terminal is provided so as to provide the identification code to each of the slave addresses. The external terminal needs to be disposed on a substrate on which the slave device is going to be mounted, causing a load in terms of maintenance. Moreover, there is also a method of providing a built-in non-volatile memory in a slave device so as to provide an identification code to the slave device. However, in the case above, the non-volatile memory needs to be pre-set according to the slave device.

### Embodiments

Details of appropriate embodiments are given with the accompanying drawings below. The same or equivalent constituent elements, parts and processes in the accompanying drawings are represented by the same denotations, and repeated description is omitted as appropriate. Moreover, in the description and drawings, different alphabet letters are sometimes appended to a same numeral or symbol to differentiate multiple constituent elements essentially having the same functional configuration. However, in case where multiple constituent elements essentially having the same functional configuration do not need to be individually differentiated, the multiple constituent elements are given the same numeral or symbol. For example, when a first signal processing device 20a and a second signal processing device 20b are not specifically differentiated, they are simply referred to as “signal processing device(s) 20”.

Moreover, the embodiments are illustrative and are not restrictive of the disclosure. All features and combinations thereof described in the embodiments are not necessarily intrinsic characteristics of the disclosure.

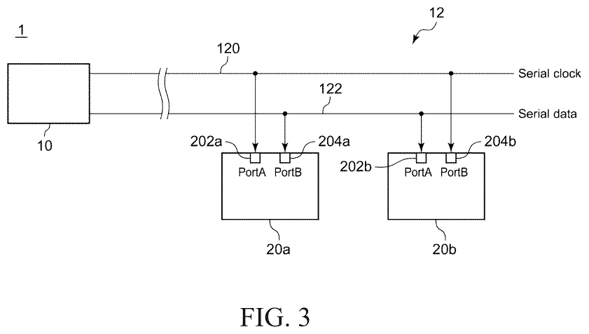

FIG. 3 shows a diagram of a configuration of a signal processing system 1 according to an embodiment of the present disclosure. The signal processing system 1 of this embodiment includes a master device 10, a communication bus 12, a first signal processing device 20a and a second signal processing device 20b.

The master device 10 transmits to and receives from the first signal processing device 20a and the second signal processing device 20b various types of information. More specifically, the master device 10 transmits a clock signal and a data signal to the first signal processing device 20a and the second signal processing device 20b or receives various types of data from the first signal processing device 20a and the second signal processing device 20b.

The first signal processing device 20a and the second signal processing device 20b perform various types of signal processing, and the two devices have essentially the same configuration as each other. The first signal processing device 20a has a first terminal 202a (Port A) and a second terminal 204a (Port B) and performs transmission and reception with the master device 10 via these terminals. The second signal processing device 20b has a first terminal 202b (Port A) and a second terminal 204b (Port B) and performs transmission and reception with the master device 10 via these terminals.

The communication bus 12 is connected to the master device 10, the first signal processing device 20a and the second signal processing device 20b, and functions as a path for transmission and reception between the master device 10 and first signal processing device 20a and between the master device 10 and the second signal processing device 20b. The communication bus 12 has a clock line 120 and a data line 122.

The clock line 120 is connected to the master device 10, the first terminal 202a of the first signal processing device 20a and the second terminal 204b of the second signal processing device 20b. The clock line 120 transmits the clock signal from the master device 10 to the first signal processing device 20a via the first terminal 202a and transmits the clock signal from the master device 10 to the second signal processing device 20b via the second terminal 204b.

The data line 122 is connected to the master device 10, the second terminal 204a of the first signal processing device 20a and the first terminal 202b of the second signal processing device 20b. The data line transmits the data signal from the master device 10 to the first signal processing device 20a via the second terminal 204a and transmits the data signal from the master device 10 to the second signal processing device 20b via the first terminal 202b. Moreover, data from the first signal processing device 20a or the second signal processing device 20b is transmitted to the master device 10 via the data line 122.

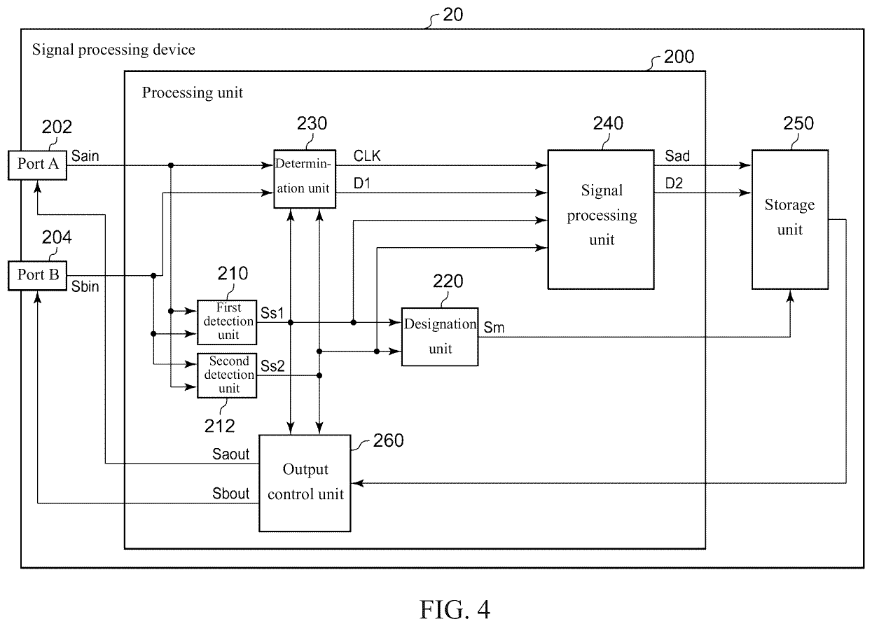

FIG. 4 shows a function block diagram of the signal processing device 20 according to an embodiment of the present disclosure. As shown in FIG. 4, the signal processing device 20 of this embodiment includes a processing unit 200, a first terminal 202, a second terminal 204, a storage unit 250 and an output control unit 260.

The first terminal 202 is input with a signal from an external device, or outputs a signal to an external device. For example, a clock signal or a data signal from the master device 10 is input into the first terminal 202. More specifically, one of a clock signal and a data signal is input into the first terminal 202 according to a connection status of the first signal processing device 20a and the communication bus 12. The signal input to the first terminal 202 is transmitted to a first detection unit 210, a second detection unit 212 and a determination unit 230. Moreover, the first terminal 202 can, for example, output data stored in the storage unit 250 to the outside.

The second terminal 204 is input with a signal from an external device, or outputs a signal to an external device. For example, a clock signal or a data signal from the master device 10 is input into the second terminal 204. More specifically, the other of a clock signal and a data signal is input into the second terminal 204 according to a connection status of the first signal processing device 20a and the communication bus 12. Even more specifically, when a clock signal is input into the first terminal 202, a data signal is input into the second terminal 204. Moreover, when a data signal is input into the first terminal 202, a clock signal is input into the second terminal 204. The signal input into the second terminal 204 is transmitted to the first detection unit 210, the second detection unit 212 and the determination unit 230. Moreover, the second terminal 204 can, for example, output data stored in the storage unit 250 to the outside.

The processing unit 200 performs various types of processing. The processing unit 200 can include a central processing unit (CPU), a random access memory (RAM) and a read only memory (ROM). Functions of the processing unit 200 of this embodiment are realized by collaboration of the first detection unit 210, the second detection unit 212, a designation unit 220, the determination unit 230 and the signal processing unit 240.

The first detection unit 210 detects a start and a stop of communication based on the clock signal and the data signal input into the first terminal 202 and the second terminal 204. The first detection unit 210 transmits a signal Ss1 indicating a detection result to the designation unit 220, the determination unit 230 and the output control unit 260.

In this embodiment, the first detection unit 210 detects the start and the stop when a clock signal is input into the first terminal 202 and a data signal is input into the second terminal 204. How the first detection unit 210 detects a start and a stop is not specifically defined, and a start and a stop of communication can be detected based on generally known protocols. For example, in case of the I2C protocol, the first detection unit 210 detects a start and a stop of communication according to a change of the data signal when the clock signal is high. More specifically, the first detection unit 210 can detect a start if the data signal changes from high to low when the clock signal is high and can detect a stop if the data signal changes from low to high when the clock signal is high.

The second detection unit 212 detects a start and a stop of communication based on the clock signal and the data signal input to the first terminal 202 and the second terminal 204. The second detection unit 212 transmits a signal Ss2 indicating a detection result to the designation unit 220, the determination unit 230 and the output control unit 260.

In this embodiment, the second detection unit 212 detects a start and a stop of communication when a data signal is input into the first terminal 202 and a clock signal is input into the second terminal 204. How the second detection unit 212 detects a start and a stop is not specifically defined, and a start and a stop of communication can be detected based on generally known protocols. For example, in case of the I2C protocol, similar to the first detection unit 210, the second detection unit 212 detects a start and a stop of communication according to a change of the data signal when the clock signal is high.

The designation unit 220 designates an address map based on the signals input into the first terminal 202 and the second terminal 204. The address map defines an address permitting data writing and an address prohibiting data writing, and more specifically, an address permitting data writing and reading, and an address prohibiting data writing and reading. More specifically, the designation unit 220 designates a first address map when a clock signal is input into the first terminal 202 and a data signal is input into the second terminal 204. Moreover, the designation unit 220 designates a second address map different from the first address map when a data signal is input into the first terminal 202 and a clock signal is input into the second terminal 204. The designation unit 220 sets the designated address map in the storage unit 250.

The determination unit 230 determines the clock signal and the data signal for the signals transmitted from the first terminal 202 and the second terminal 204. At this point in time, the determination unit 230 can use the detection results of a start in the first detection unit 210 and the second detection unit 212. The determination unit 230 transmits a clock signal CLK and a data signal D1 to the signal processing unit 240 based on a determination result.

The signal processing unit 240 performs various types of signal processing. More specifically, the signal processing unit 240 performs data writing on the storage unit 250. The signal processing unit 240 obtains sub address information Sad and data D2 based on the data signal D1 transmitted from the determination unit 230 and accesses the storage unit 250 based on the sub address information Sad to write the data D2 to the storage unit 250. At this point in time, the signal processing unit 240 writes the data to the storage unit 250 according to the address map set in the storage unit 250.

The storage unit 250 stores various types of data. The storage unit 250 of this embodiment consists of a register and a memory. The storage unit 250 is set with an address map that defines an address permitting data writing and an address prohibiting data writing.

The output control unit 260 controls an output of data. More specifically, the output control unit 260 reads data stored in the storage unit 250, and outputs the read data from the first terminal 202 or the second terminal 204. In this embodiment, the output control unit 260 outputs data from the first terminal 202 or the second terminal 204 according to the address map designated by the designation unit 220. More specifically, the output control unit 260 selects a terminal for outputting read data according to an address map designated by the designation unit 220, and outputs the data from the selected terminal.

For example, the output control unit 260 can select, based on the detection results of the first detection unit 210 and the second detection unit 212, a terminal for outputting the read data. More specifically, the output control unit 260 outputs data from the second terminal 204 when the first detection unit 210 detects a start (the first address map is designated), and the output control unit 260 outputs data from the first terminal 202 when the second detection unit 212 detects a start (the second address map is designated). However, when an address in an address map prohibiting data reading is a read target, data is output from neither of the terminals since the output control unit 260 does not read data from the address.

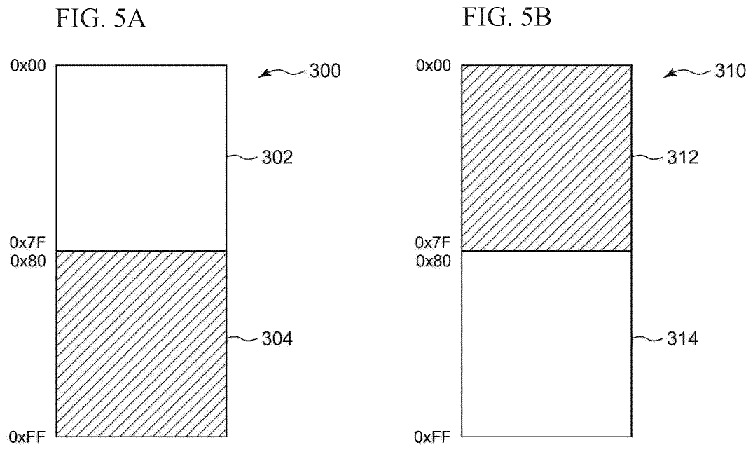

Referring to FIG. 5A and FIG. 5B, address maps set in the storage unit 250 of this embodiment are described below. FIG. 5A shows a diagram of a first address map 300 of this embodiment, and FIG. 5B shows a diagram of a second address map 310 of this embodiment.

As shown in FIG. 5A, the first address map 300 includes two address regions 302 and 304. The address region 302 includes sub addresses 0x00 to 0x7F, which allow data writing according to access of the signal processing unit 240 and are thus written with data. The address region 304 includes sub addresses 0x80 to 0xFF, which prohibit data writing according to access of the signal processing unit 240 and are thus not written with data.

As shown in FIG. 5B, the second address map 310 includes two address regions 312 and 314. The address region 312 includes sub addresses 0x00 to 0x7F, which prohibit data writing according to access of the signal processing unit 240 and are thus not written with data. The address region 314 includes sub addresses 0x80 to 0xFF, which allow data writing according to access of the signal processing unit 240 and are thus written with data.

Moreover, in this embodiment, an example in which an address region where data is written and an address region where data is not written are divided as halves in the address map is given. However, the means for dividing address regions is not limited to the example above. For example, an address permitting data writing and an address prohibiting data writing can be alternately relocated to form an address map, or one of an address region permitting data writing and an address region prohibiting data writing can be configured to be greater than the other to form an address map.

Thus, in this embodiment, the sub addresses (0x00 to 0x7F) permitting data writing in the first address map 300 become sub addresses prohibiting data writing in the second address map 310. On the other hand, the addresses (0x80 to 0xFF) prohibiting data writing in the first address map 300 become sub addresses permitting data writing in the second address map 310.

The signal processing unit 240 performs data writing according to the address maps above. For example, when the storage unit 250 is set with the first address map 300, the signal processing unit 240 can write data to the address region 302 but cannot write data to the address region 304. On the other hand, when the storage unit 250 is set with the second address map 310, the signal processing unit 240 cannot write data to the address region 312 but can write data to the address region 314.

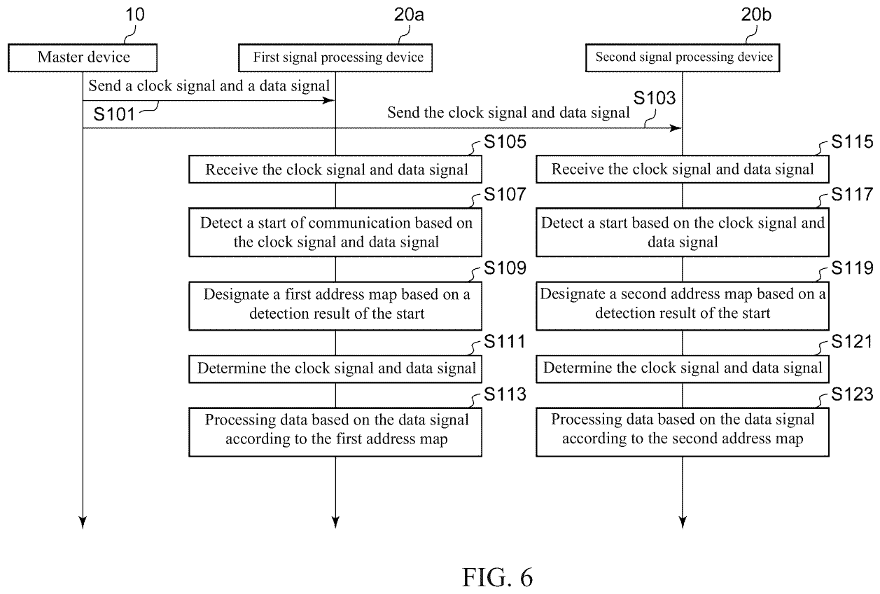

Referring to FIG. 6, an operation example of the signal processing system 1 according to an embodiment of the present disclosure is described below. An operation process of the signal processing system 1 is described with reference to the flowchart in FIG. 6.

First of all, the master device 10 sends a clock signal and a data signal to each of the first signal processing device 20a and the second signal processing device 20b (S101, S103). An operation of the second processing device 20b is described after the description of an operation of the first signal processing device 20a.

The first signal processing device 20a receives the clock signal and the data signal sent from the master device 10 (S105). More specifically, the clock signal is input into the first terminal 202a of the first signal processing device 20a, and the data signal is input into the second terminal 204a of the first signal processing device 20a.

Next, the first signal processing device 20a detects a start of communication based on the clock signal and the data signal (S107). Herein, the first detection unit 210 of the first signal processing device 20a detects a start of communication based on the clock signal and the data signal.

Next, the first signal processing device 20a designates the first address map based on a detection result of the start (S109). Herein, since the first detection unit 210 detects a start, the designation unit 220 of the first signal processing device 20a designates the first address map between the first address map and the second address map and sets the first address map in the storage unit 250.

Next, the first signal processing device 20a determines the clock signal and the data signal (S111). More specifically, the determination unit 230 of the first signal processing device 20a determines the clock signal and the data signal based on signals input into the first terminal 202a and the second terminal 204a.

Next, the first signal processing device 20a processes data based on the data signal determined in S111 according to the first address map. At this point in time, the signal processing unit 240 can write data to the sub addresses 0x00 to 0x7F. Moreover, the signal processing unit 240 cannot write data to the sub addresses 0x80 to 0xFF.

The operation of the second signal processing device 20b is described below. The second signal processing device 20b receives the clock signal and the data signal sent from the master device 10 (S115). More specifically, the data signal is input into the first terminal 202b of the second signal processing device 20b, and the clock signal is input into the second terminal 204b of the second signal processing device 20b.

Next, the second signal processing device 20b detects a start of communication based on the clock signal and the data signal (S117). Herein, the second detection unit 212 of the second signal processing device 20b detects a start of communication based on the clock signal and the data signal.

Next, the second signal processing unit 20b designates the second address map based on a detection result of the start (S119). Herein, since the second detection unit 212 of the second signal processing device 20b detects a start, the designation unit 220 of the second signal processing device 20b designates the second address map between the first address map and the second address map and sets the second address map in the storage unit 250. Thus, in this embodiment, the first signal processing device 20a and the second signal processing device 20b set address maps different from each other in the storage unit 250.

Next, the second signal processing device 20b determines the clock signal and the data signal. More specifically, the determination unit 230 of the second signal processing device 20b determines the clock signal and the data signal based on signals input into the first terminal 202b and the second terminal 204b.

Next, the second signal processing device 20b processes data based on the data signal according to the second address map (S123). At this point in time, the signal processing unit 240 cannot write data to the sub addresses 0x00 to 0x7F. Moreover, the signal processing unit 240 can write data to the sub addresses 0x80 to 0xFF.

According to the above, the master device 10 performs data writing in the first signal processing device 20a when the sub addresses 0x00 to 0x7F are designated. On the other hand, the master device 10 performs data writing in the second signal processing device 20b when the sub addresses 0x80 to 0xFF are designated. Moreover, during data reading, the master device 10 receives read data from the sub addresses 0x00 to 0x7F for the first signal processing device 20a and receives read data from the sub addresses 0x80 to 0xFF for the second signal processing device 20b.

An operation example of the signal processing system 1 of this embodiment is described as above; however, the steps shown in FIG. 6 are not necessarily performed in the order shown in the drawing. Multiple steps can be simultaneously performed or performed in parallel, and the order of the steps can be modified according to requirements.

According to the signal processing system 1 of this embodiment, the master device 10 is capable of communicating with two signal processing devices 20 substantially have the same configuration. In this embodiment, in the first signal processing device 20a and the second signal processing device 20b, connections of the first terminal 202 and the second terminal 204 with the clock line 120 and the data line 122 are opposite to each other. Accordingly, even when the address map set in each of the signal processing devices 20 is different, signal processing corresponding to the address map can be performed. Thus, an external terminal or a pre-set non-volatile memory as in the reference example is not needed, and the master device 10 can easily and readily communicate with two signal processing devices 20 by means of adjusting the connections of the first signal processing device 20a and the second signal processing device 20b.

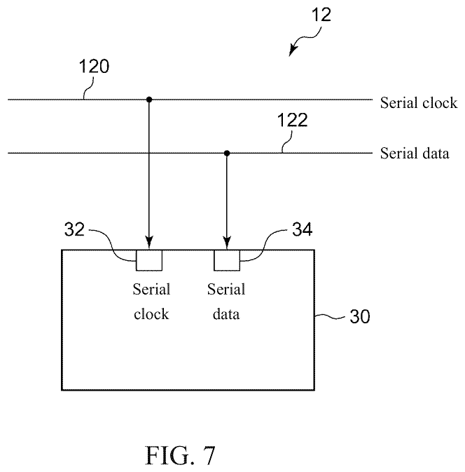

FIG. 7 shows a diagram of the two signal processing devices 20 observed from the master device 10 of this embodiment. In practice, as described above, the communication bus 12 is connected to the two signal processing devices 20 including the first signal processing device 20a and the second signal processing device 20b. However, the same identification code is assigned in these signal processing devices 20, and so the master device 10 can communicate with the two signal processing devices 20 by using the same identification code. Thus, as shown in FIG. 7, the master device 10 can communicate with the first signal processing device 20a and the second signal processing device 20b, as if communicating with one signal processing device 30 provided with the identification code.

### Variation Examples

Moreover, in this embodiment, an example in which an address map defining an address region where data is read/written and an address region where data is not read/written is given. In the variation example, in the first address map and the second address map, an address where data is read and written is shared and an address determining whether to access the address is included. The remaining parts of the configuration and operation details are the same as those of the embodiment above. Moreover, the configurations of the embodiment and the variation example can also be combined as desired.

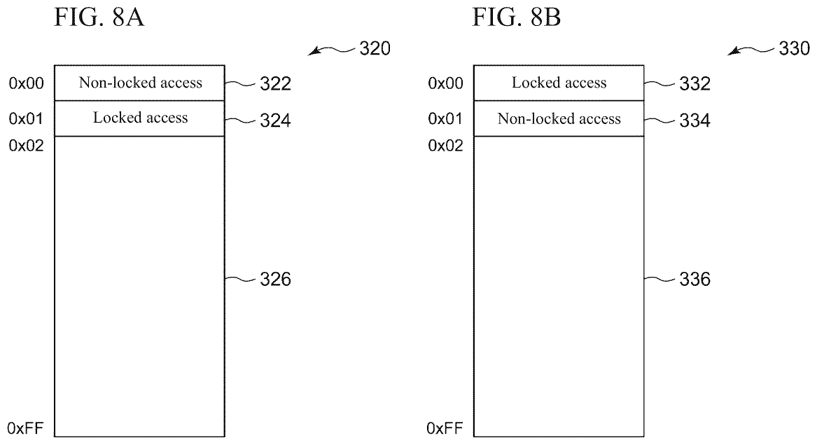

FIG. 8A shows a diagram of a first address map 320 of the variation example, and FIG. 8B shows a diagram of a second address map 330 of the variation example.

The first address map 320 includes a non-locked address 322, a locked address 324 and a reading/writing region 326. The reading/writing region 326 consists of sub addresses 0x02 to 0xFF written with data. The non-locked address 322 is a sub address 0x00 permitting access of the reading/writing region 326, and the locked address 324 is a sub address 0x01 prohibiting access of the reading/writing region 326.

The signal processing unit 240 accesses the non-locked address 322 or the locked address 324 when the first address map 320 is set in the storage unit 250, and processes data according to the accessed address. More specifically, the signal processing unit 240 is permitted to access the reading/writing region 326 and write data to the reading/writing region 326 when accessing the non-locked address 322, and the signal processing unit 240 is prohibited from accessing the reading/writing region 326 when accessing the locked address 324. Moreover, when the signal processing device 20 is prohibited from accessing the reading/writing region 326 and cannot read data in the reading/writing region 326, it can output a signal Hiz indicating the above.

The second address map 330 includes a locked address 332, a non-locked address 334 and a reading/writing region 336. The reading/writing region 336 consists of sub addresses 0x02 to 0xFF written with data, which are the same addresses as those of the reading/writing region 326 of the first address map 320. The locked address 332 is an address 0x00 prohibiting access of the reading/writing region 336, and the non-locked address 334 is an address 0x01 permitting access of the reading/writing region 336. Thus, in the second address map 330, the locked address and the non-locked address are addresses opposite to those of the first address map 320.

The signal processing unit 240 accesses the locked address 332 or the non-locked address 334 of the second address map 330 when the second address map 330 is set in the storage unit 250, and processes data according to the accessed address. More specifically, the signal processing unit 240 is prohibited from accessing the reading/writing region 336 and writing data to the reading/writing region 336 when accessing the locked address 332. The signal processing device 20 is prohibited from accessing the reading/writing region 336. The signal processing unit 240 is permitted to access the reading/writing region 336 and write data to the reading/writing region 336 when accessing the non-locked address 334. Moreover, when the signal processing device 20 is prohibited from accessing the reading/writing region 336 and cannot read data in the reading/writing region 336, it can output a signal Hiz indicating the above.

Thus, in the first address map 320 and the second address map 330, by setting the unlocked addresses and the locked addresses to be opposite, the master device 10 can communicate with the two signal processing devices 20 as in the embodiment.

Moreover, regarding the reading/writing regions 326 and 336 of the address maps of the variation example, part of the addresses can be set as an address region permitting data reading/writing and the remaining addresses can be set as an address region prohibiting data reading/writing, as given in the description associated with FIG. 5A and FIG. 5B.

### Application Example

In the embodiment, an example that the master device 10 transmits data to and receives data from one of the first signal processing device 20a and the second signal processing device 20b in one instance of communication is primarily described. In the application example, an example that the master device 10 transmits a signal to and receives a signal from both of the first signal processing device 20a and the second signal processing device 20b in one instance of communication is described. Moreover, the remaining configuration and operation details of the application example are the same as those of the embodiments described with reference to FIG. 3 and FIG. 4. Moreover, the configurations of the embodiment, the variation example and the application example can also be combined as desired.

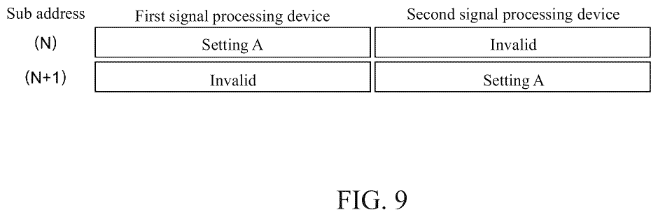

FIG. 9 shows a diagram of address maps set in the first signal processing device 20a and the second signal processing device 20b of the application example. In the address map of the first signal processing device 20a, a sub address (N) has a setting A, and a sub address (N+1) is set as invalid. On the other hand, in the address map of the second signal processing device 20b, a sub address (N) is set as invalid, and a sub address (N+1) has a setting A. Moreover, the setting A is a setting permitting data reading/writing of the address.

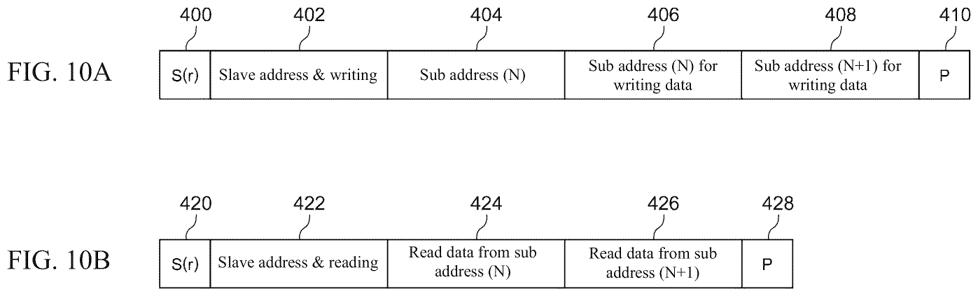

FIG. 10A is a diagram of a communication process of writing data to the storage unit 250 of the signal processing device 20. The master device 10 sends start information 400 indicating a start of communication, and then sends slave address information 402 instructing to write data. With the slave address information 402, both of the first signal processing device 20a and the second signal processing device 20b identify the communication.

Next, the master device 10 sends written data 406 for the sub address (N), then sends data that is written data 408 of the next address of the sub address (N), that is, a sub address (N+1), and lastly sends stop information 410 indicating an end of the communication. In response, the first signal processing device 20a writes data to the sub address (N), and the second signal processing device 20b writes data to the sub address (N+1).

Thus, in the first signal processing device 20a and the second signal processing device 20b, the setting A and invalid are pre-set in opposite for the sub address (N) and the sub address (N+1). Accordingly, the master device 10 can send data to the first signal processing device 20a and the second signal processing device 20b by means of sending written data to two consecutive sub addresses (that is, the sub addresses (N) and (N+1)) in one instance of communication.

FIG. 10B shows a diagram of a communication process of reading data from the storage unit 250 of the signal processing device 20. The master device 10 sends start information 420 indicating a start of communication, and then sends slave address information 422 instructing to read data. With the slave address information 422, both of the first signal processing device 20a and the second signal processing device 20b identify the communication.

Next, the first signal processing device 20a reads data written in the sub address (N) and sends the read data 424 to the master device 10. At this point in time, since the first signal processing device 20a does not read the sub address (N+1), it can output the signal Hiz. The second signal processing device 20b reads data written in the sub address (N+1) and sends the read data 426 to the master device 10. At this point in time, since the second signal processing device 20b does not read data of the sub address (N), it can output the signal Hiz. Then, stop information indicating an end of the communication is sent to end the communication.

According to the signal processing system 1 of the present disclosure, data writing and reading can be performed in one instance of communication by the two signal processing devices 20 as in the application example.

### (Supplement)

Although specific terms are used to describe the embodiments of the present disclosure, it is to be noted that the description merely provides examples for better understanding and is not to be construed as limitations to the present disclosure or the scope of the appended claims. The scope of the present disclosure is defined by the appended claims. Moreover, implementations, embodiments and variations examples not described herein are also encompassed within the scope of the present disclosure.

### [Notes]

An aspect of the techniques disclosed by the present application can be understood with reference to the following.

### (Item 1)

A signal processor, comprising:
a first terminal, into which one of a clock signal and a data signal is input;
a second terminal, into which another one of the clock signal and the data signal is input;
a storage unit, in which an address map is set to define an address permitting data writing and an address prohibiting data writing;
a designation unit, configured to designate the address map set in the storage unit; and
a processing unit, configured to write a data based on the data signal to the storage unit according to the address map designated by the designation unit,
wherein the designation unit designates a first address map when the clock signal is input into the first terminal and the data signal is input into the second terminal and designates a second address map different from the first address map when the data signal is input into the first terminal and the clock signal is input into the second terminal.

### (Item 2)

The signal processor of Item 1, further comprising:
a first detection unit, configured to detect a start of communication based on the clock signal and the data signal when the clock signal is input into the first terminal and the data signal is input into the second terminal; and
a second detection unit, configured to detect a start of communication based on the clock signal and the data signal when the data signal is input into the first terminal and the clock signal is input into the second terminal,
wherein the designation unit designates the first address map when the first detection unit detects a start and designates the second address map when the second detection unit detects a start.

### (Item 3)

The signal processor of Item 1 or 2, wherein each of the first address map and the second address map includes a first address and a second address; the first address, in the first address map, permits data writing and reading that data writing and reading are performed, and in the second address map, prohibits data writing and reading that data writing and reading are not performed; and the second address, in the first address map, prohibits data writing and reading that data writing and reading are not performed, in the second address map, permits data writing and reading that data writing and reading are performed.

### (Item 4)

The signal processor of Item 1 or 2, wherein each of the first address map and the second address map includes a first address, a second address and a write address to which data is writable; the first address, in the first address map, permits data to be written to the write address, and in the second address map, prohibits data to be written to the write address; and the second address, in the first address map, prohibits data to be written to the write address, and in the second address map, permits data to be written to the write address.

### (Item 5)

The signal processor of any one of Items 1 to 4, further comprising an output control unit configured to output a data written in the storage unit from the first terminal or the second terminal according to the address map designated by the designation unit.

### (Item 6)

A signal processing system, comprising:
a first signal processing device and a second signal processing device respectively configured by the signal processor of any one of Items 1 to 5,
wherein the first signal processing device is configured that the data signal is input into a first terminal of the first signal processing device, and the clock signal is input into a second terminal of the first signal processing device,
the second signal processing device is configured that the clock signal is input into a first terminal of the second signal processing device, and the data signal is input into a second terminal of the second signal processing device.

### (Item 7)

The signal processing system of Item 6, wherein the data signal is configured that data is written to the storage unit of the first signal processing device according to the first address map, and data is written to the storage unit of the second signal processing device according to the second address map.

1. A signal processor, comprising:
a first terminal, into which one of a clock signal and a data signal is input;
a second terminal, into which another one of the clock signal and the data signal is input;
a storage unit, in which an address map is set to define an address permitting data writing and an address prohibiting data writing;
a designation unit, configured to designate the address map set in the storage unit; and
a processing unit, configured to write a data based on the data signal to the storage unit according to the address map designated by the designation unit, wherein the designation unit
designates a first address map when the clock signal is input into the first terminal and the data signal is input into the second terminal, and
designates a second address map different from the first address map when the data signal is input into the first terminal and the clock signal is input into the second terminal.

2. The signal processor of claim 1, further comprising:
a first detection unit, configured to detect a start of communication based on the clock signal and the data signal when the clock signal is input into the first terminal and the data signal is input into the second terminal; and
a second detection unit, configured to detect a start of communication based on the clock signal and the data signal when the data signal is input into the first terminal and the clock signal is input into the second terminal, wherein
the designation unit
designates the first address map when the first detection unit detects a start, and
designates the second address map when the second detection unit detects a start.

3. The signal processor of claim 1, wherein
each of the first address map and the second address map includes a first address and a second address,
the first address
in the first address map, permits data writing and reading that data writing and reading are performed, and
in the second address map, prohibits data writing and reading that data writing and reading are not performed; and
the second address
in the first address map, prohibits data writing and reading that data writing and reading are not performed,
in the second address map, permits data writing and reading that data writing and reading are performed.

4. The signal processor of claim 1, wherein
each of the first address map and the second address map includes a first address, a second address and a write address to which data is writable,
the first address,
in the first address map, permits data to be written to the write address, and
in the second address map, prohibits data to be written to the write address; and
the second address,
in the first address map, prohibits data to be written to the write address, and
in the second address map, permits data to be written to the write address.

5. The signal processor of claim 1, further comprising an output control unit configured to output a data written in the storage unit from the first terminal or the second terminal according to the address map designated by the designation unit.

6. A signal processing system, comprising:
a first signal processing device and a second signal processing device respectively configured by the signal processor of claim 1, wherein
the first signal processing device is configured that the data signal is input into a first terminal of the first signal processing device, and the clock signal is input into a second terminal of the first signal processing device,
the second signal processing device is configured that the clock signal is input into a first terminal of the second signal processing device, and the data signal is input into a second terminal of the second signal processing device.

7. The signal processing system of claim 6, wherein the data signal is configured that
data is written to the storage unit of the first signal processing device according to the first address map, and
data is written to the storage unit of the second signal processing device according to the second address map.
